(19) United States
(12) Patent Application Publication
(10) Pub. No.: US 2014/0114687 A1
(43) Pub. Date: Apr. 24, 2014

(54) Systems And Methods For Real-Time Rehabilitation Records Tracking

(71) Applicants: Harrison Gabe Frank, Wilmington, NC (US); Kirk Steele, Waterloo (CA)

(72) Inventors: Harrison Gabe Frank, Wilmington, NC (US); Kirk Steele, Waterloo (CA)

(21) Appl. No.: 14/057,735

(22) Filed: Oct. 18, 2013

Related U.S. Application Data
(60) Provisional application No. 61/716,230, filed on Oct. 19, 2012.

(51) Int. Cl. G06F 19/00

(52) U.S. Cl. CPC G06F 19/3418; G06F 19/322
USPC 705/3

(57) ABSTRACT

Systems and methods for real-time rehabilitation records tracking are disclosed. For example, one disclosed method for real-time rehabilitation records tracking includes the steps of executing a software application by a processor in communication with a memory; receiving, by the software application, patient treatment data, the patient treatment data associated with a patient and a treatment test; and generating and displaying, by the software application, a graphical visualization of patient progress based on the patient treatment data.

### CROSS REFERENCES TO RELATED APPLICATIONS

This application claims priority to U.S. Provisional Patent Application No. 61/716,230, filed Oct. 19, 2012, entitled “Systems and Methods for Real-Time Rehabilitation Records Tracking, the entirety of which is hereby incorporated by reference.

### COPYRIGHT NOTIFICATION

A portion of the disclosure of this patent document and its attachments contain material which is subject to copyright protection. The copyright owner has no objection to the facsimile reproduction by anyone of the patent document or the patent disclosure, as it appears in the Patent and Trademark Office patent files or records, but otherwise reserves all copyrights whatsoever.

### FIELD

The present disclosure relates generally to rehabilitation performance evaluation and more specifically to methods, systems and computer readable media for real-time rehabilitation records tracking.

### BACKGROUND

In conventional therapy practice, a therapist, such as an occupational therapist, will maintain handwritten notes of therapy sessions with patients during the sessions. After completing all patient visits for a day, the therapist transfers the handwritten notes to a formal medical record of the visit. The data from the medical record is then later entered into a computer system, where it is stored and available for later use. This process results in redundant work—data entries are made three times in this case—and can take several days to complete. Further, because data is entered multiple times over an extended period of time, there are greater opportunities for mistakes to occur, or for data or records to be lost. Additionally the electronic records that are ultimately created are generally used for patient billing and recordkeeping, not for analysis of patient progress during a course of therapy.

### SUMMARY

Embodiments according to the present disclosure provide systems and methods for providing real-time rehabilitation records tracking. For example, one disclosed embodiment is a method comprising executing a software application by a processor in communication with a memory; receiving, by the software application, patient treatment data, the patient treatment data associated with a patient and a treatment plan; in response to receiving said patient treatment data, storing the patient treatment data at a remote server in real-time; and generating and displaying, by the software application, a graphical visualization of patient progress based on the patient treatment data. In another embodiment, a computer-readable medium comprises program code for causing one or more processors to execute such a method.

These illustrative embodiments are mentioned not to limit or define the disclosure, but rather to provide examples to aid understanding thereof. Illustrative embodiments are discussed in the Detailed Description, which provides further description of the disclosure. Advantages offered by various embodiments of this disclosure may be further understood by examining this specification.

### BRIEF DESCRIPTION OF THE DRAWINGS

The accompanying drawings, which are incorporated into and constitute a part of this specification, illustrate one or more examples of embodiments and, together with the description of example embodiments, serve to explain the principles and implementations of the embodiments.

FIGS. 1-2B show systems for real-time rehabilitation records tracking according to embodiments;

FIG. 3 shows a method for real-time rehabilitation records tracking according to one embodiment; and

FIGS. 4-14 show screenshots of a system for real-time rehabilitation records tracking according to one embodiment.

### DETAILED DESCRIPTION

Example embodiments are described herein in the context of systems and methods for real-time rehabilitation records tracking. Those of ordinary skill in the art will realize that the following description is illustrative only and is not intended to be in any way limiting. Other embodiments will readily suggest themselves to such skilled persons having the benefit of this disclosure. Reference will now be made in detail to implementations of example embodiments as illustrated in the accompanying drawings. The same reference indicators will be used throughout the drawings and the following description to refer to the same or like items.

Illustrative Method for Real-Time Rehabilitation Records Tracking

In one illustrative embodiment, a method for real-time rehabilitation records tracking may be used to provide real-time, or near-real-time, feedback to a physical therapist (“PT”) regarding a patient's progress during a physical therapy regime. To provide such functionality, a PT executes a software application on a tablet computer, such as an iPad®, for tracking a patient's progress during physical therapy. To setup a new patient for therapy, the PT uses the application to create a profile for a new patient and enters various data about the patient, such as name, age, height, weight, social security number (SSN), or other pertinent data that may be useful. The PT then creates a treatment plan for the patient based on her injury or injuries as well as an initial assessment of the patient's condition prior to physical therapy, such as flexibility, pain associated with movements, etc. The PT selects one or more therapies or tests for the patient to perform as a part of the treatment plan. In this illustrative embodiment, the PT selects one or more pre-defined tests or therapies that are included within the software application.

After selecting the tests or therapies for a treatment plan, the PT begins treating the patient according to the plan. For example, during each visit, the PT works with the patient according to the treatment plan and guides the patient through one or more of the tests selected as a part of the plan. As the patient completes each test, the PT selects the test completed within the application and enters data from the test into the software application. For example, if the test measures the patient's ability to walk unassisted, the PT may measure the distance the patient is able to walk or a number of steps walked without assistance of the PT or other mechanical device. The PT then enters the measured data into the software application, which sends the data to a remote server that is compliant with the Health Insurance Portability and Accountability Act (HIPAA), which stores the data in a data file associated with the patient's record.

After the test data is entered, the PT can then immediately analyze the patient's progress over time, including the most recently-performed test. For example, the PT can select a tool to view a graph showing the distance walked by the patient after each test performed during the course of treatment. The application requests the data from the remote server, which remote server the relevant data to the software application. The software application then generates a visualization of the data (e.g. a graph in this case) for the PT to view. Thus, the PT can immediately see whether the patient appears to be improving or not, as well as by how much. The PT can then modify the treatment plan based on the patient's progress or lack thereof.

This illustrative example is given to introduce the reader to the general subject matter discussed herein and this disclosure is not limited to this example. The following sections describe various additional non-limiting embodiments and examples of devices, systems, and methods for real-time rehabilitation records tracking.

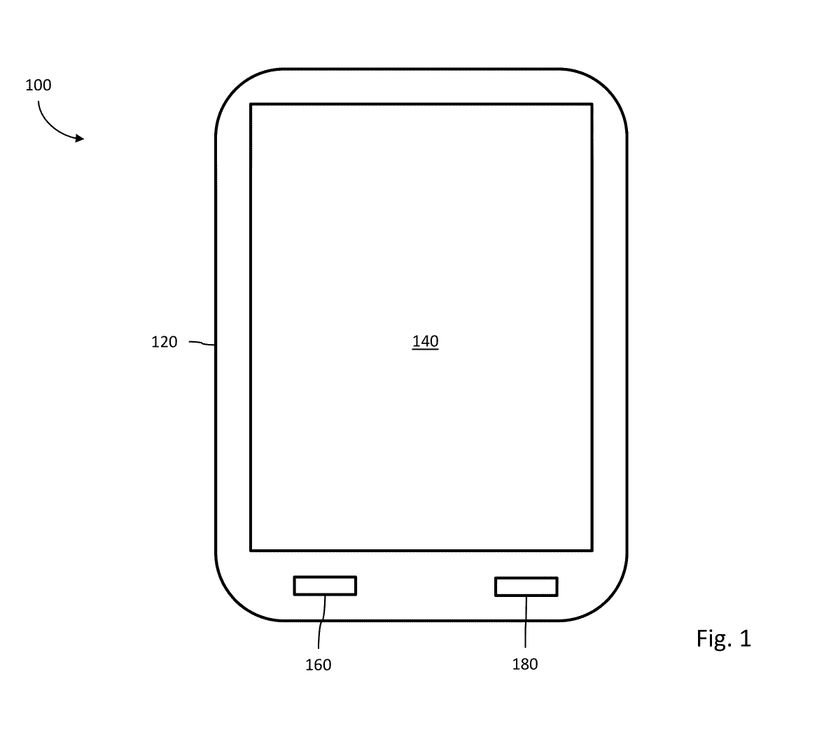

Referring now to FIG. 1, FIG. 1 shows a system 100 for real-time rehabilitation records tracking according to one embodiment of the present disclosure. The device 100 has a housing 120 and a touch-sensitive input device 140 incorporated into a display. In addition, two buttons 160, 180 are provided on the housing that are configured to be pressed by a user and to provide signals to the device 100. Within the device 100, but not shown, are a processor and a memory for executing software code.

The device 100 shown in FIG. 1 is configured to execute a software application for real-time rehabilitation records tracking. For example, the device's processor may load and execute a software application stored in memory, or may execute a web browser application and load a webpage having a web application for real-time rehabilitation records tracking. Embodiments of the device 100 may comprise other features, such as network interfaces, such as WiFi, Ethernet, USB, or other wired or wireless communication interfaces. In some embodiments, the device may be configured to execute a standalone application for real-time rehabilitation records tracking and may be configured to save data to a persistent data storage medium, such as a flash drive, within the device 100. As mentioned above, in some embodiments, the device 100 may be configured to execute a web application or a front-end application for a server-based application real-time rehabilitation records tracking, as will be described in greater detail below.

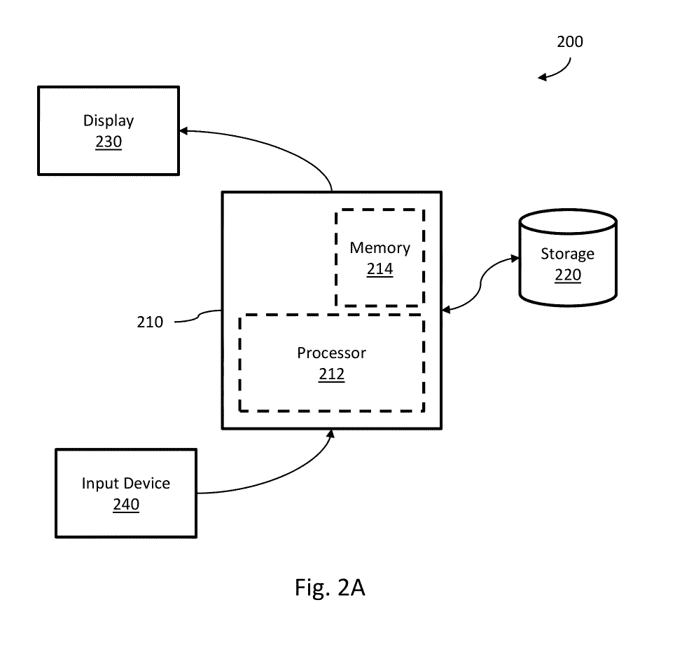

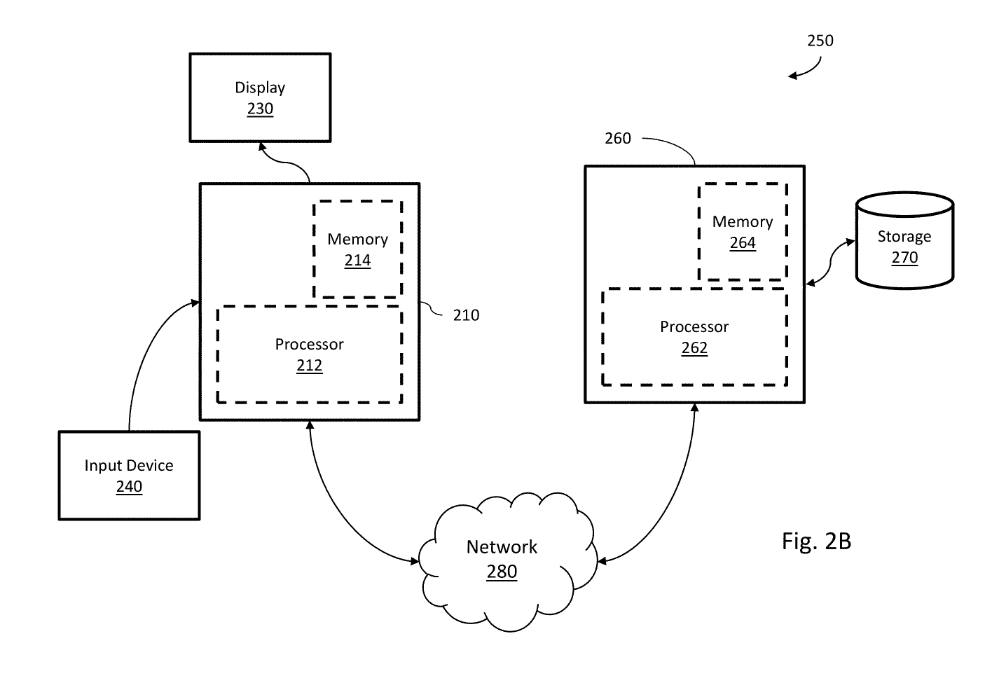

Referring now to FIG. 2A, FIG. 2A shows a system 200 for real-time rehabilitation records tracking according to one embodiment of the present disclosure. The system 200 shown in FIG. 2A comprises a computer 210, which comprises a processor 212 and a memory 214, where the processor 212 is in communication with the memory 214. The computer 210 is in communication with a display 230 and an input device 240, as well as storage device 220.

In the embodiment shown in FIG. 2A, the processor 212 is in communication with memory 214 and is configured to execute a software application that provides real-time rehabilitation records tracking according to various embodiments. The software application may be stored within the memory 214 or in another memory, either local to or remote from the computer 210. The software application, as will be described in greater detail below, is configured to receive rehabilitation data from the input device 240 or from a computer-readable medium, such as memory 214 or storage device 220.

In some embodiments, the input device 240 may comprise a computer mouse, a joystick, a stylus, a camera (e.g. a video camera), or a flash memory reader that is coupled to or in communication with the computer 210. For example, in one embodiment, the real-time rehabilitation records tracking application may be configured to receive rehabilitation data from a keyboard displayed on a touch-sensitive display 240 connected to the computer 210. In some embodiments, the input device 240 may be comprise other types of input devices. For example, in one embodiment, the input device 240 comprises keyboard and a mouse.

Signals from the input device 240 may be transmitted to the computer via a communications bus, such as USB, FireWire, or other suitable communications interface. The processor 212 receives such signals and processes them to determine actions responsive to said signals. For example, if signals received from the input device 240 comprise signals from a touch-sensitive input device, the processor 212 may receive the signals and provide information from the signals to the real-time rehabilitation records tracking application to process rehabilitation data.

The processor 212 is also in communication with storage device 220, which is configured store data. In some embodiments, the storage device 220 comprises a non-volatile computer readable medium, such as a hard disk, coupled to or disposed within the computer. In some embodiments, the storage device 220 is remote from the computer 210, such as a network-connected hard disk or a remote database system. In some embodiments, the processor 212 is configured to generate a file to store data, such as data received from the input device 240, in the storage device 220, or to store output data, such as visualizations based on rehabilitation data used by a real-time rehabilitation records tracking application.

Referring now to FIG. 2B, FIG. 2B shows a system 250 for real-time rehabilitation records tracking according to one embodiment of the present disclosure. The system 250 shown in FIG. 2B comprises a computer 210, which comprises a processor 212 and a memory 214, where the processor 212 is in communication with the memory 214. The computer 210 is in communication with a display 230 and an input device 240. In addition, the computer 210 is in communication with second computer 260 via network 280. In the embodiment shown in FIG. 2B, the second computer 260 comprises a processor 262 and a computer-readable medium 264, and is in communication with storage device 270.

In the embodiment shown in FIG. 2B client computer 210 is configured to execute a front end for a software application for real-time rehabilitation records tracking and the remote computer 260 is configured to execute processing for the software application for real-time rehabilitation records tracking. In one embodiment, remote computer 260 comprises a server system having one or more servers configured to comply with various HIPAA data storage requirements. For example, the client computer 210 receives rehabilitation data from an input device, such as a from a keyboard or a touch-sensitive input device, and transmits the rehabilitation data to the second computer 260 across the network 280. The processor 262 in the second computer is configured to receive the rehabilitation data and execute a real-time rehabilitation records tracking process. The second processor 262 then generates one or more signals to transmit to the first computer 210 based on output of the real-time rehabilitation records tracking process. The processor 212 at the first computer 210 receives the signals from the second computer 260 and generates one or more display signals based on the signals from the second computer 260. The processor 212 then transmits the display signals to the display 230, which displays one or more images based on the display signals.

Storage device 270 in the embodiment shown in FIG. 2B comprises a server executing a relational database management system; however, in some embodiments, data storage 270 may comprise other types of data storage. For example, in one embodiment data storage 270 may comprise an object-oriented database or a transactional database. In some embodiments, data storage 270 may comprise one or more hard drives configured to store flat files. Further, storage device 270 may comprise other types of data storage devices, such as network attached storage (NAS) or storage area networks (SAN).

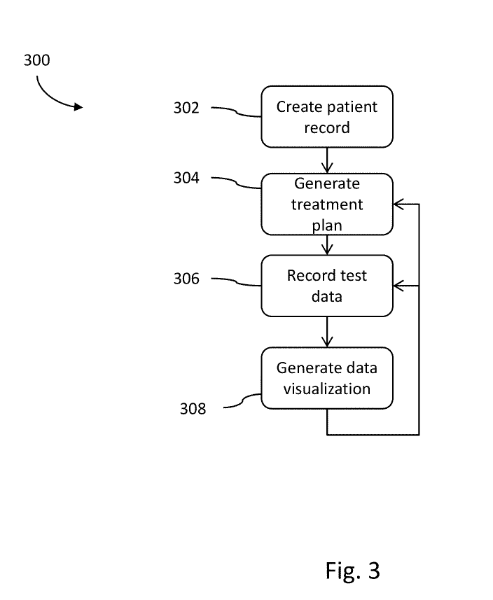

Referring now to FIG. 3, FIG. 3 shows a method 300 according to one embodiment. The method 300 shown in FIG. 3 will be described in the context of a software application executed by the system 250 shown in FIG. 2B. However this and other embodiments are not restricted to use only on the system 250 of FIG. 2B. Other embodiments according to this disclosure are suitable for performing the method 300 of FIG. 3, such as the system 200 shown in FIG. 2A as well as other systems within the scope of this disclosure.

The method 300 begins in block 302 when a user of the client computer 210 launches a web-browser and accesses a website having a software application for real-time rehabilitation records tracking. While this embodiment comprises a web-based software application, other embodiments may comprise a software application executed by the client computer that is capable of working offline or without the use of a remote server 260. For example, the user may employ a laptop computer to execute a native software application that stores all patient records and test data locally without use of a remote server. In one embodiment, the user execute a native software application that is configured to communicate with a remote server 260 to store and retrieve patient records and test data.

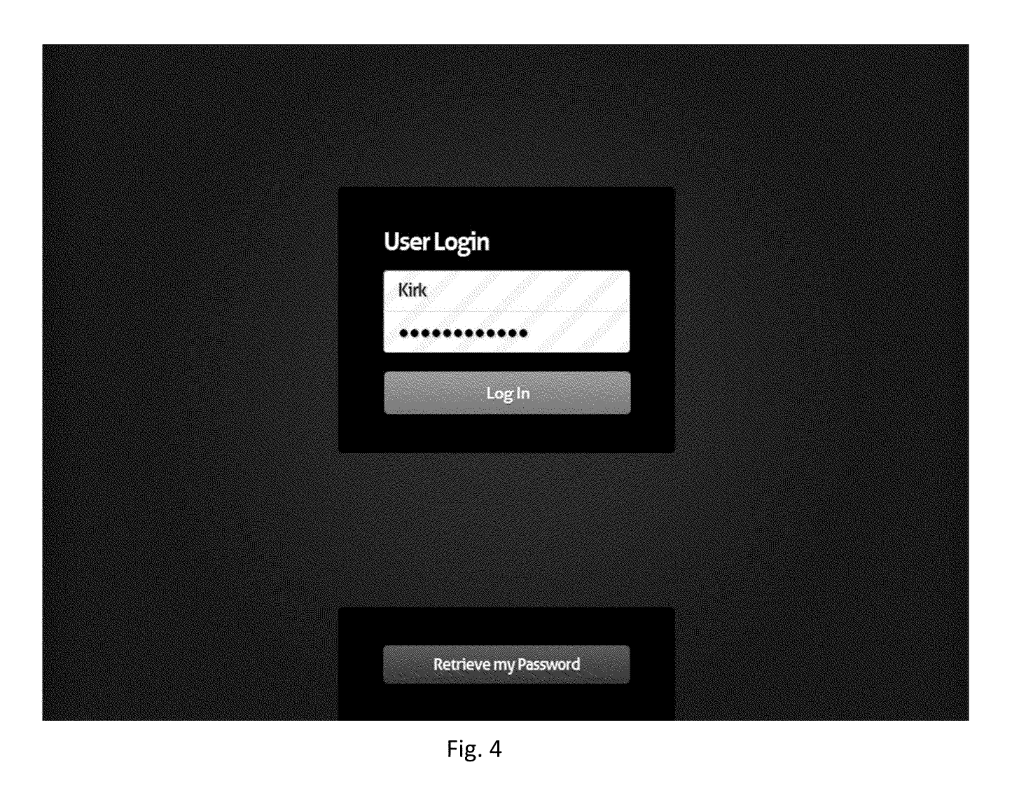

In this embodiment, the user enters login information, such as a login name and password. FIG. 4 shows a screenshot of a login screen according to one embodiment. After logging into the application, the user creates a new patient record to enroll a new patient in a therapy treatment plan. In this embodiment, the user is a physical therapist and the software application is configured to provide functionality related to physical therapy, other embodiments according to this disclosure may be configured for other types of therapy, such as occupational therapy, speech therapy, physical therapy, etc., or for a plurality of types of therapy within the same application.

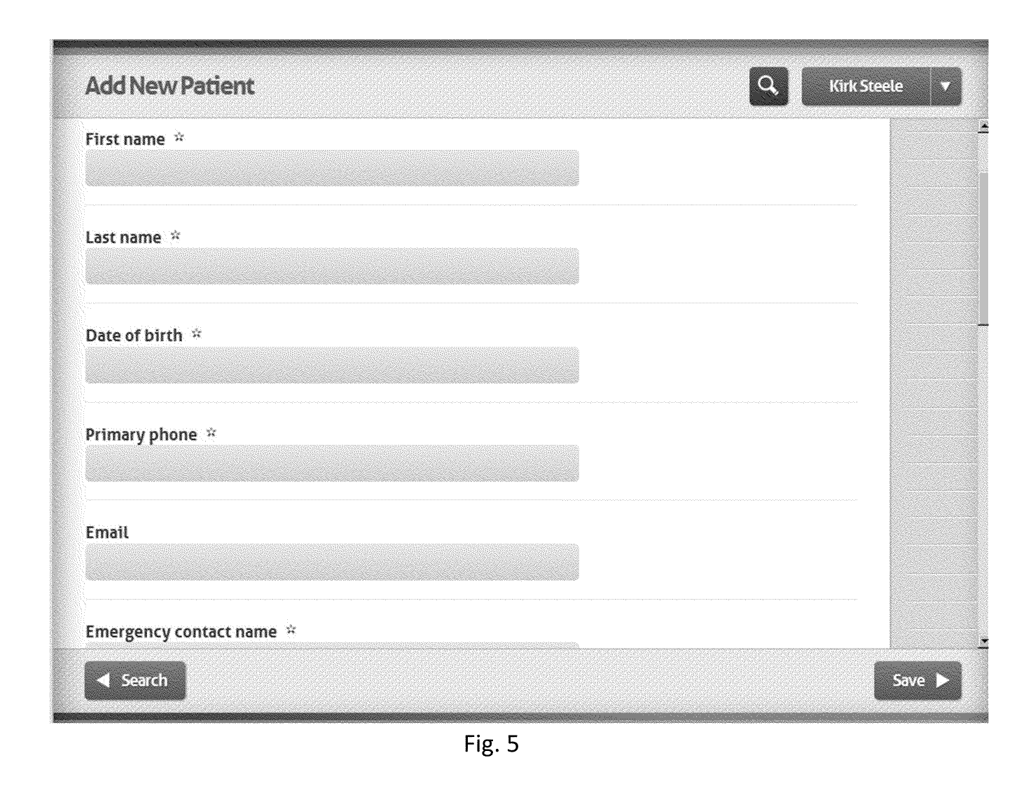

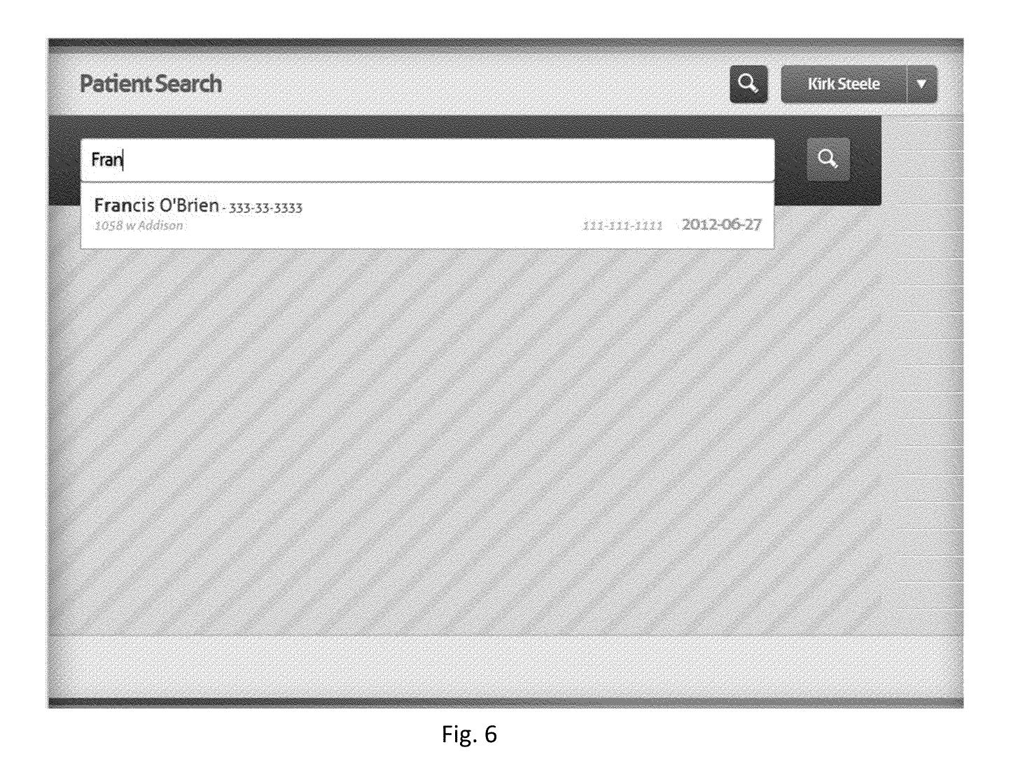

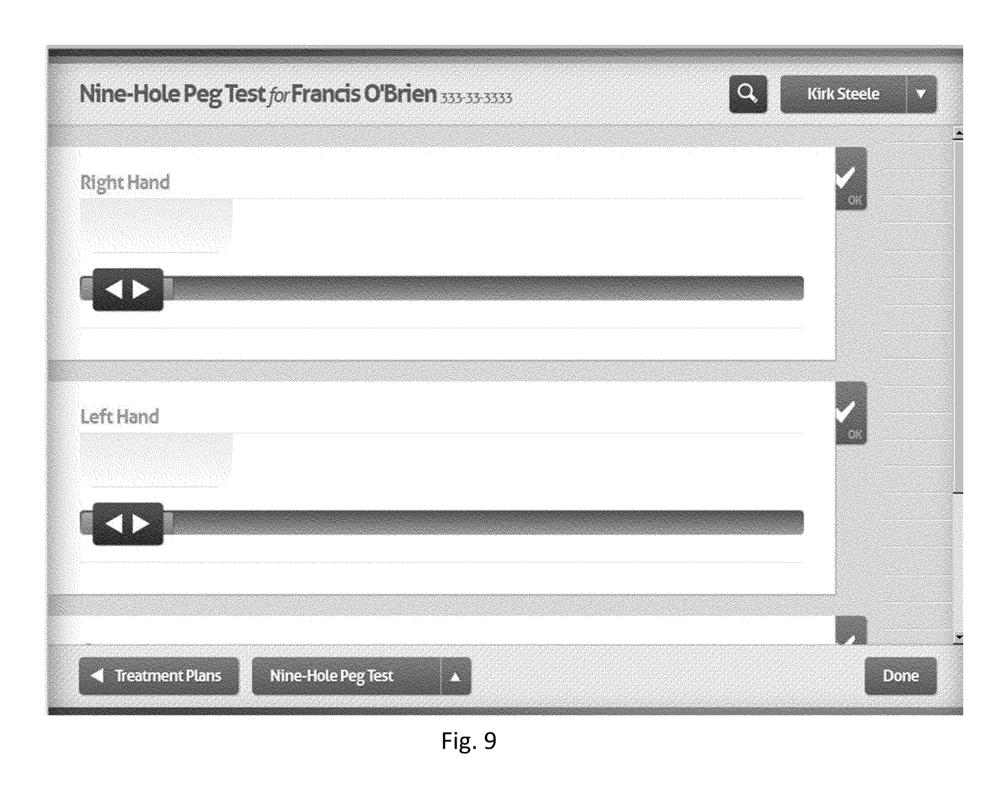

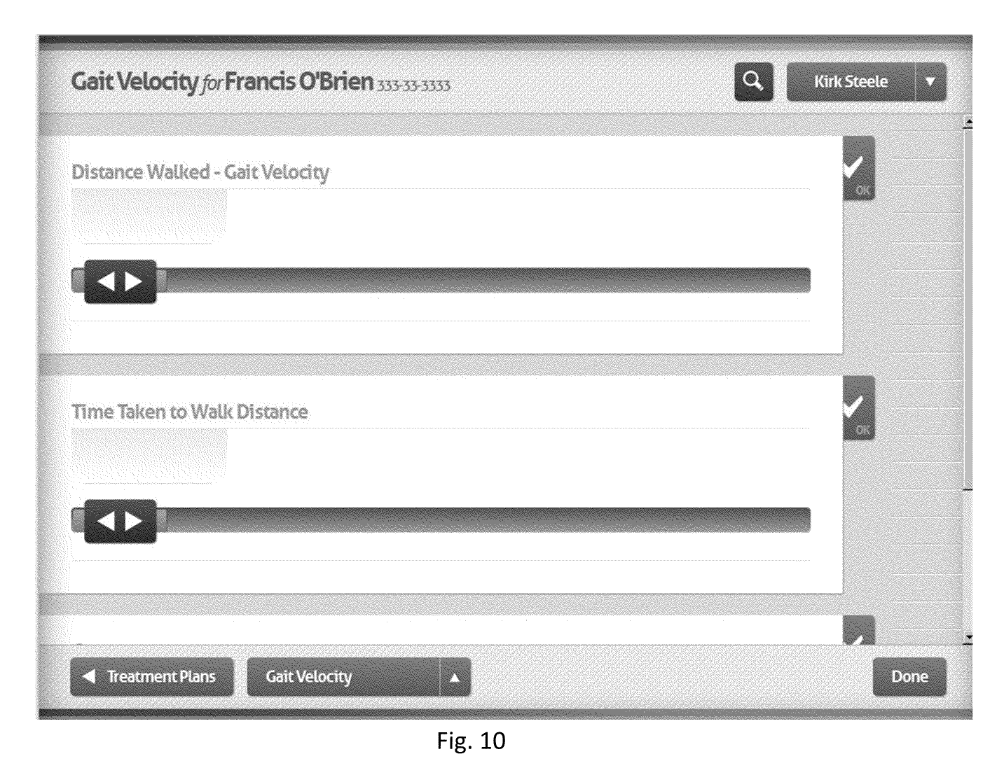

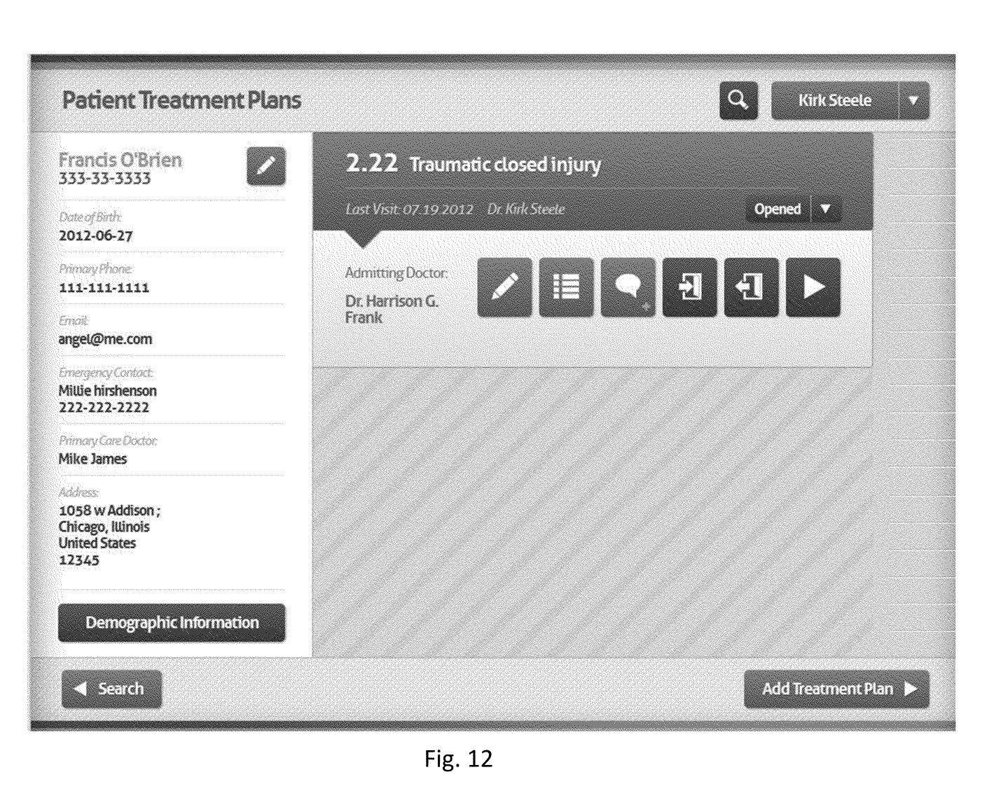

In this embodiment, as may be seen in FIGS. 4-14, the software application presents the user with a graphical user interface (GUI) with which to interact with the software application. To create the patient record in this embodiment, the user (or PT) selects on option to create a new patient record within the application's GUI, which then presents the user with a number of fields in which to enter patient information, such as name, age, height, weight, gender, etc. An example embodiment of a screen to add a new patient is shown in FIG. 5. After the user has entered the patient information, the user selects a ‘save’ option to complete creation of the patient record. In the embodiment shown in FIG. 5, a ‘save’ button is shown in the lower right corner of the screen. In some embodiments, a user may search for an existing patient record, rather than creating a new record. FIG. 6 shows a screenshot of a patient record search screen according to one embodiment. As is shown in FIG. 6, a user may type in a patient's name, or part of a patient's name, and then press the search button, which comprises a magnifying glass icon in this embodiment. As may also be seen in this embodiment, the application automatically begins searching for patient records and provides candidate records as the user types the patient's name. In this case, the user has type “Fran” and the application has located a record for a patient named “Francis O'Brien.”

In the embodiment shown in FIG. 5, after the user selects the save option, the patient record is created and transmitted to the remote computer 260, where it is stored in non-volatile memory, though in some embodiments, the records may be created and stored immediately, either on the local computer or the remote server or both. In the embodiment, the remote computer 260 comprises a HIPAA-compliant server located in a hospital data center. In this embodiment, the patient record is stored as a record in a database 270 in communication with the remote computer 260, though in some embodiments, other data storage mechanisms may be used, such as flat files. In addition, a local copy of the patient record is maintained within the client computer for use during a patient's therapy session. In this embodiment, the master data record is maintained on the remote server 260, while the copy stored on the client computer 210 is simply a temporary copy of the master data record. In this embodiment, the temporary copy is only stored in volatile memory, such as RAM, though in some embodiments, the temporary copy may be stored in a non-volatile memory within the client computer 210, such as for later offline retrieval. After the patient record has been created, the method 300 proceeds to block 304.

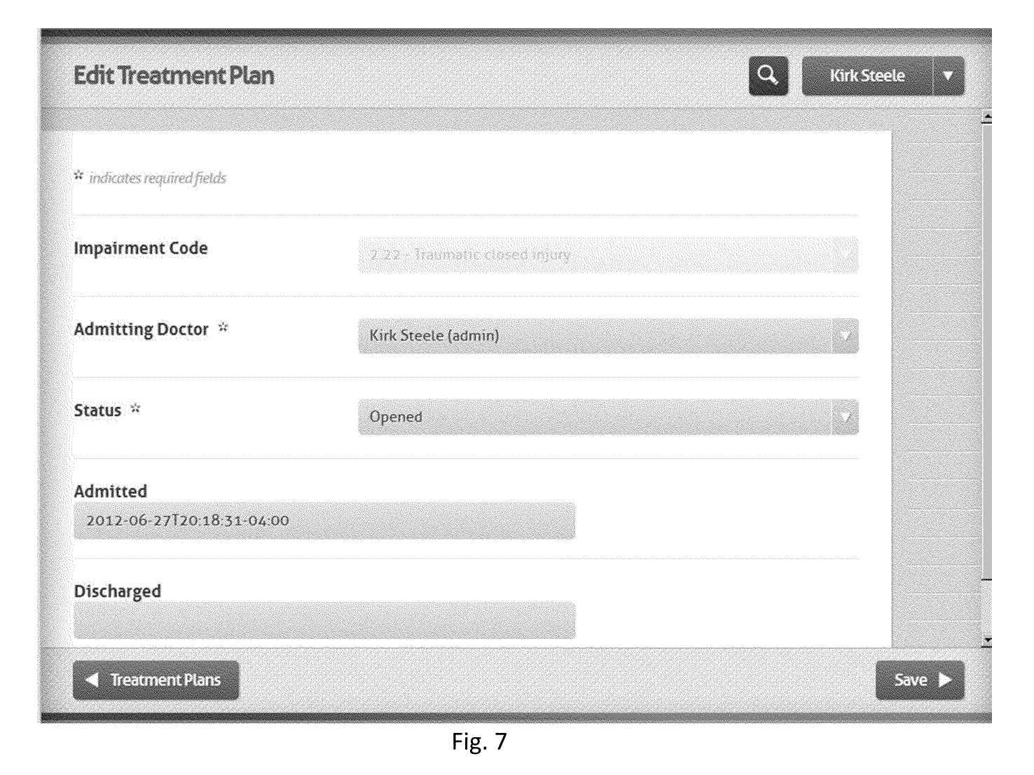

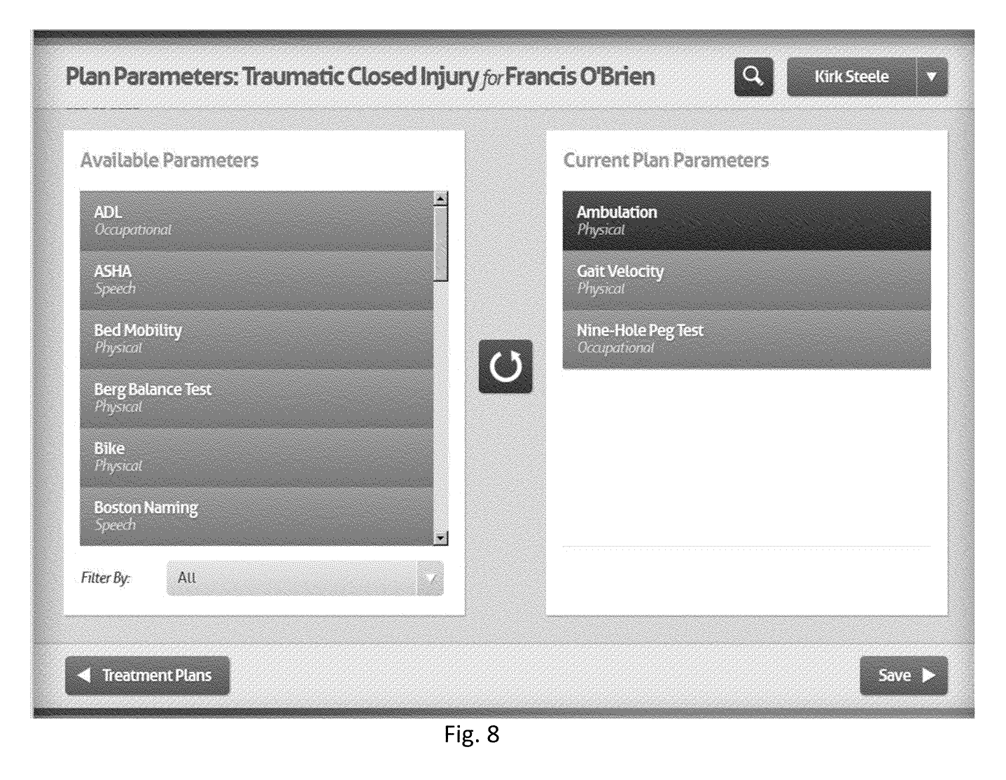

In block 304, the user creates a treatment plan. To create a treatment plan according to this embodiment, the user accesses an “Edit Treatment Plan” screen of the application, such as may be seen in the screenshot shown in FIG. 6, and may perform various tasks, such as selecting the admitting doctor and setting the status of the treatment plan. In addition, the user may select one or more treatments for a patient. In this embodiment, the software application is pre-configured with a number of pre-defined tests for use within a physical therapy treatment plan. FIG. 7 shows a screenshot of a partial set of available plan parameters according to one embodiment. The user may then select one or more of the test to be added to a treatment plan for the patient, which is stored as a part of the patient record. For example, in the embodiment shown in FIG. 7, the use has selected three different plan parameters: ambulation, gait velocity, and the nine-hole peg test. In different embodiments, a user may select plan parameters for different types of therapy. For example, in the screenshot shown in FIG. 7, two physical therapy and one occupational therapy parameter have been selected. In some embodiments, different or other types of therapy parameters may be used. For example, FIGS. 8-10 show different example plans for speech, occupational, and physical therapy that may be selected or adjusted by the PT.

In addition, to selecting the various treatment plan parameters, each individual parameter may be adjusted. For example, FIGS. 8-10 show targets or goals for different treatment parameters, such as a target distance to be walked or a goal time to walk a defined distance. A user may adjust such parameters by sliding the slider bars to different positions, corresponding to different values.

In some embodiments, a treatment plan may be generated and stored in a data file separately from a particular patient record and may be associated with one or more patient records. For example, a user may create one or more general-purpose treatment plans for a particular type of injury or therapy, which may be stored for later use with various suitable patients. After selecting the appropriate tests for a treatment plan, the user saves the treatment plan and the software application transmits the treatment plan data to the remote server 260 for storage. As with the patient record, the data stored at the remote server 260 is the master data, for this embodiment, while the copy stored on the client computer is a only temporary copy.

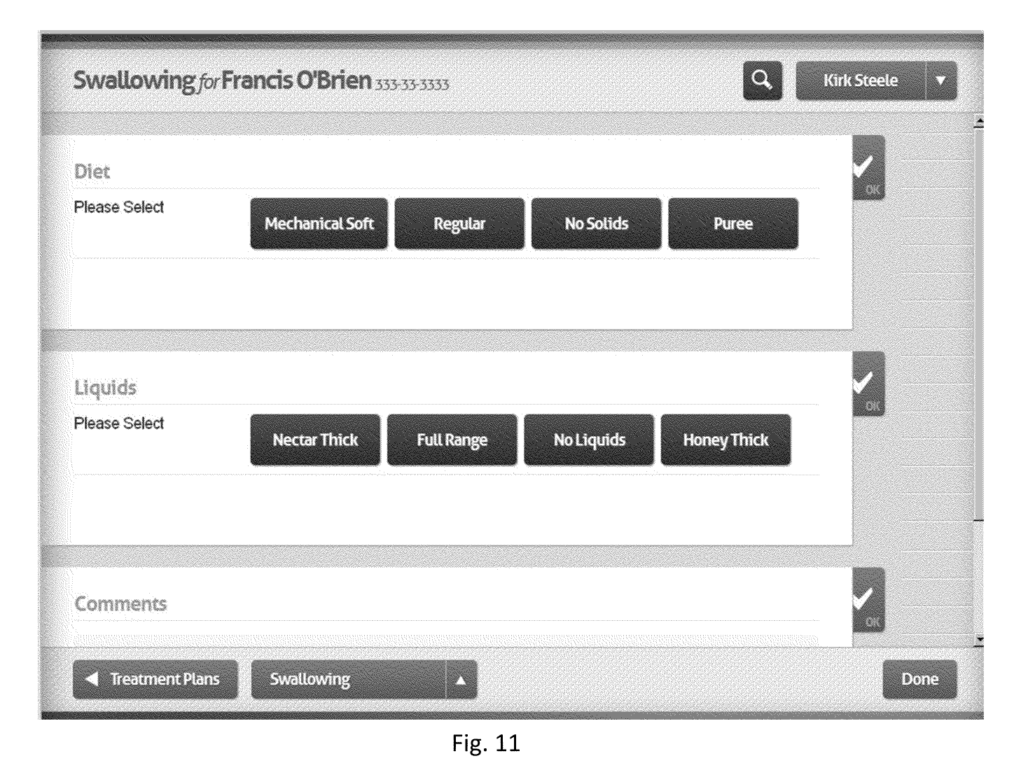

After a treatment plan has been created for a patient, the plan may be viewed within the patient's record. For example, FIG. 11 shows a patient record with a corresponding treatment plan. As may be seen, additional treatment plans may be created for a patient, such as by selecting other available plan parameters on the screen shown in FIG. 7, or by creating a new, custom plan. For example, a user may select an option to create a new, custom plan, and enter a name for the plan and identify one or more parameters to be tracked by the plan. The new, custom plan may then be stored, such as on the remote server and may be made available for use with other patients or may be usable only for a single patient. After the treatment plan has been generated, the method proceeds to block 306.

In block 306, the user records test data using the software application. For example, in one embodiment, a treatment plan for a user comprises a plurality of tests to be performed during a patient's therapy session. As the patient completes each of the tests, the user records data associated with each test. For example, as discussed above, the data may comprise a distance or a number of steps walked without assistance, a range of motion as a part of a flexibility test, etc. The software application in this embodiment provides data entry fields associated with each test for receiving test data from the user. After data for a test has been entered, the user selects a save option to store the data permanently. After the user selects the save option, the data is transmitted to the remote server 260 for permanent storage. In some embodiments, data may be automatically, periodically saved or saved immediately upon entry. In this embodiment, data for each test is stored as separate records in a database. After the test data has been recorded and saved, the method proceeds to block 308.

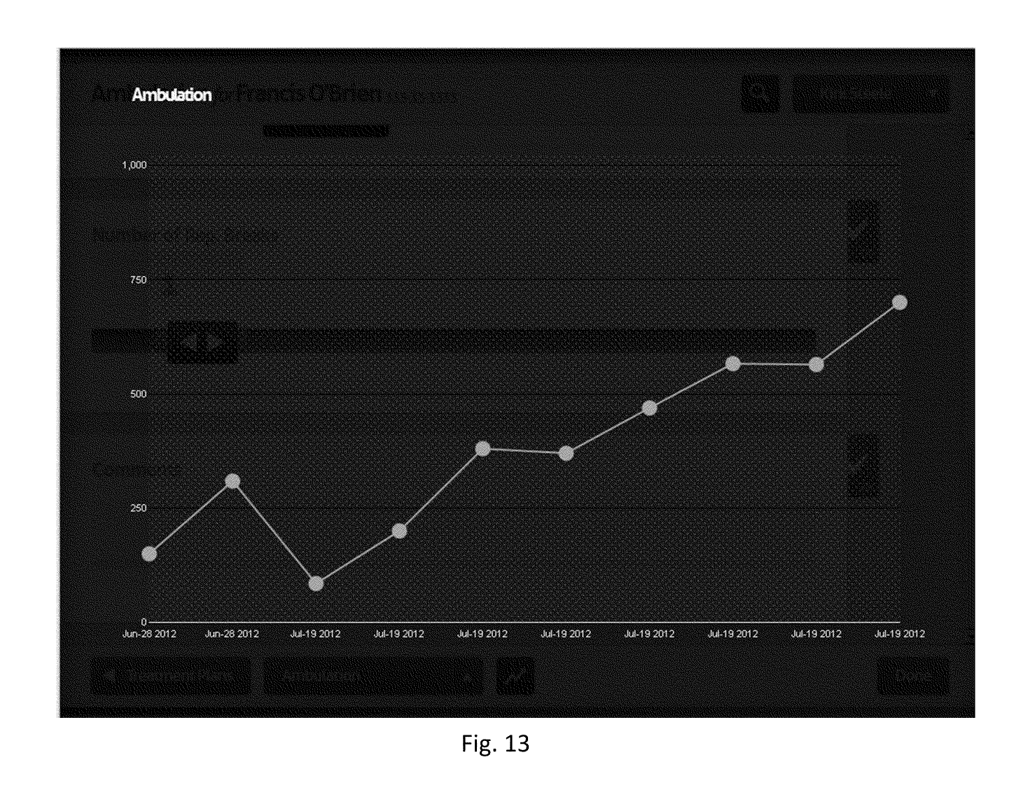

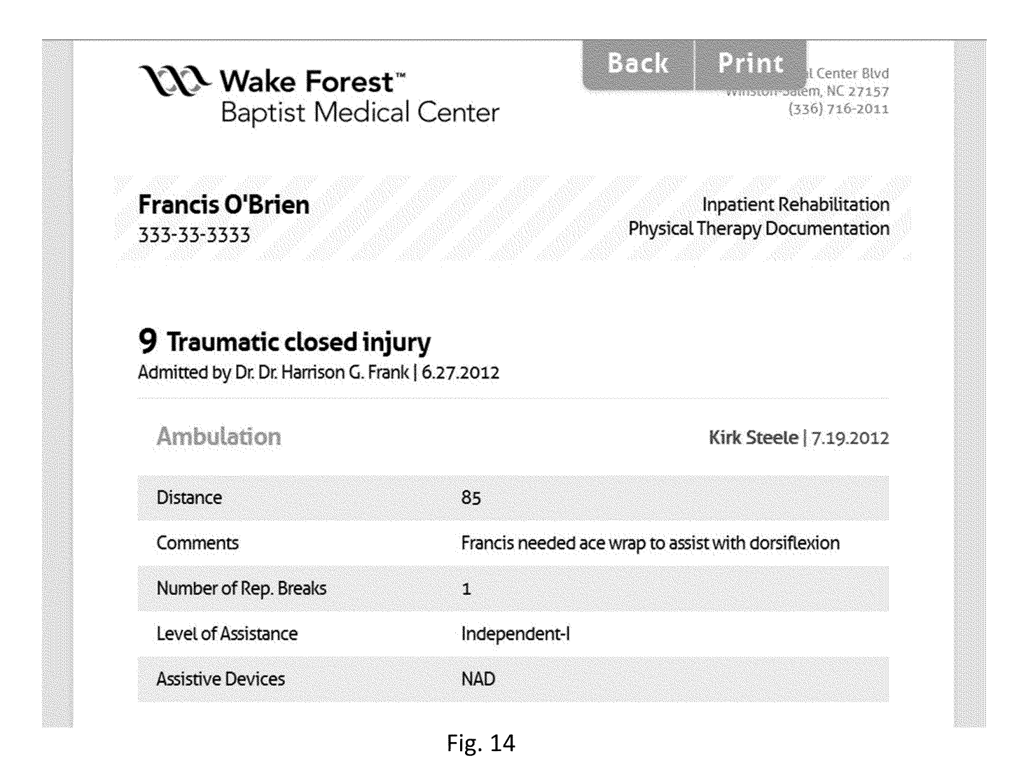

In block 308, the software application generates one or more data visualizations using recorded test data. For example, in one embodiment, the software application receives recorded test data from the remote server and generates a line graph based on test data indicating a distance walked without assistance by a patient over a plurality of therapy visits. In some embodiments, some or all of the recorded test data may be stored on the device 100 and thus no recorded test data, or only a portion of the recorded test data is received from the remote server. For example, FIG. 13 shows a data plot of patient records on successive attempts at an ambulation test. In the embodiment shown, the number of steps taken is represented by the y-axis, while the date of the test is shown in the x-axis. By viewing the visualization, the user may determine whether a patient is improving or not and may decide whether to continue with the existing treatment plan or to modify the plan. For example, in one embodiment, a user may modify one or more parameters associated with the plan and the modification or the plan comprising the modification may be transmitted to the remote server. In some embodiments, other types of visualizations may be provided. For example, FIG. 14 shows a patient therapy record for one ambulation test. For example, in this embodiment, the user has selected one of the points on the graph shown in FIG. 13 and has been presented with detailed information regarding the test results. As may be seen, the test results include the measured data, such as the distance travelled, the number of breaks, the level of assistance, and the assistive devices used. In addition, a user may enter comments, such as comments regarding events occurring within the test or other freeform notes. In this embodiment, the user has entered a comment indicating that the patient needed an ace bandage wrap to assist with dorsiflexion.

Embodiments according to the present disclosure may provide significant advantages over existing systems and methods for tracking rehabilitation records. For example, embodiments may allow for immediate entry of rehabilitation data and the elimination of handwritten notes and subsequent data entry procedures. Further, real-time analysis may allow a user to quickly assess a patient's progress or identify areas for improvement. Further, because data may be stored in a central repository in some embodiments, the data can be accessed from a variety of locations and reviewed for other purposes, such as effectiveness of particular physical therapists based on progress of multiple patients over time, or to improve billing or revenue projection function.

### General

While the methods and systems herein are described in terms of software executing on various machines, the methods and systems may also be implemented as specifically-configured hardware, such a field-programmable gate array (FPGA) specifically to execute the various methods. For example, referring again to FIGS. 1-2B, embodiments can be implemented in digital electronic circuitry, or in computer hardware, firmware, software, or in a combination of thereof. In one embodiment, a device may comprise a processor or processors. The processor comprises a computer-readable medium, such as a random access memory (RAM) coupled to the processor. The processor executes computer-executable program instructions stored in memory, such as executing one or more computer programs for editing an image. Such processors may comprise a microprocessor, a digital signal processor (DSP), an application-specific integrated circuit (ASIC), field programmable gate arrays (FPGAs), and state machines. Such processors may further comprise programmable electronic devices such as PLCs, programmable interrupt controllers (PICs), programmable logic devices (PLDs), programmable read-only memories (PROMs), electronically programmable read-only memories (EPROMs or EEPROMs), or other similar devices.

Such processors may comprise, or may be in communication with, media, for example computer-readable media, that may store instructions that, when executed by the processor, can cause the processor to perform the steps described herein as carried out, or assisted, by a processor. Embodiments of computer-readable media may comprise, but are not limited to, an electronic, optical, magnetic, or other storage device capable of providing a processor, such as the processor in a web server, with computer-readable instructions. Other examples of media comprise, but are not limited to, a floppy disk, CD-ROM, magnetic disk, memory chip, ROM, RAM, ASIC, configured processor, all optical media, all magnetic tape or other magnetic media, or any other medium from which a computer processor can read. The processor, and the processing, described may be in one or more structures, and may be dispersed through one or more structures. The processor may comprise code for carrying out one or more of the methods (or parts of methods) described herein.

The foregoing description of some embodiments has been presented only for the purpose of illustration and description and is not intended to be exhaustive or to limit the disclosure to the precise forms disclosed. Numerous modifications and adaptations thereof will be apparent to those skilled in the art without departing from the spirit and scope of the disclosure.

Reference herein to “one embodiment” or “an embodiment” means that a particular feature, structure, operation, or other characteristic described in connection with the embodiment may be included in at least one implementation of the disclosure. The disclosure is not restricted to the particular embodiments described as such. The appearance of the phrase “in one embodiment” or “in an embodiment” in various places in the specification does not necessarily refer to the same embodiment. Any particular feature, structure, operation, or other characteristic described in this specification in relation to “one embodiment” may be combined with other features, structures, operations, or other characteristics described in respect of any other embodiment.

1. A method for tracking and reporting rehabilitation performance, the method comprising:
executing a software application by a processor in communication with a memory;
receiving, by the software application, patient treatment data, the patient treatment data associated with a patient and a treatment test;
in response to receiving said patient treatment data, storing the patient treatment data at a remote server in real-time; and
generating and displaying, by the software application, a statistical and graphical visualization of patient progress based on the patient treatment data.

2. The method of claim 1, further comprising receiving the software application from a remote server.

3. The method of claim 2, wherein the software application is configured to be executed by a web browser application.

4. The method of claim 1, further comprising
receiving, by the software application, patient information and generating, by the software application, a patient record based on the patient information, the patient information comprising a medical condition;
providing, by the software application, a plurality of pre-defined treatment tests, at least some of the plurality of pre-defined treatment test associated with the medical condition;
receiving, by the software application, a selection of at least one of the pre-defined treatment tests; and
associating, by the software application, the selected treatment test with the patient record.

5. The method of claim 4, further comprising:
transmitting the patient record to a remote server;
transmitting the patient treatment data to the remote server, and
wherein associating the selected treatment test with the patient record comprises transmitting the selected treatment test to the remote server.

6. The method of claim 1, further comprising receiving at least a portion of the patient treatment data from a remote server.

7. The method of claim 1, further comprising receiving a modification of the treatment test, the modification based at least in part on the graphical visualization.

8. The method of claim 7, further comprising transmitting the modification to a remote server.

9. A device comprising:
an input device;
a computer-readable medium; and
a processor in communication with the input device and the computer-readable medium, the processor configured to execute a software application stored in the computer-readable medium, the software application configured to cause the processor to:
receive patient treatment data, the patient treatment data associated with a patient and a treatment test;
responsive to receiving said patient treatment data, store the patient treatment data at a remote server in real-time; and
generate a display signal, the display signal configured to generate a graphical visualization of patient progress based on the patient treatment data.

10. The device of claim 9, further comprising a display in communication with the processor, the display configured to receive the display signal and, in response to receiving the display signal, display the graphical visualization.

11. The device of claim 9, wherein the input device comprises a touch-sensitive display.

12. The device of claim 9, wherein the software application is further configured to cause the processor to:
receive patient information and generate a patient record based on the patient information, the patient information comprising a medical condition;
provide a plurality of pre-defined treatment tests, at least some of the plurality of pre-defined treatment tests associated with the medical condition;
receive a selection of at least one of the pre-defined treatment tests; and
associate the selected treatment test with the patient record.

13. The device of claim 12, wherein the software application is further configured to cause the processor to:
transmitting the patient record to a remote server;
transmitting the patient treatment data to the remote server, and
wherein associating the selected treatment test with the patient record comprises transmitting the selected treatment test to the remote server.

14. The device of claim 9, wherein the software application is further configured to cause the processor to receive at least a portion of the patient treatment data from a remote server.

15. The device of claim 9, wherein the processor is configured to receive the software application from a remote server.

16. The device of claim 15, wherein the software application is configured to be executed by a web browser application.

17. The device of claim 9, wherein the software application is further configured to cause the processor to receive a modification of the treatment test, the modification based at least in part on the graphical visualization.

18. The device of claim 17, wherein the software application is further configured to cause the processor to transmit the modification to a remote server.

19. The device of claim 17, wherein the device comprises a handheld device.

20. A computer-readable medium comprising program code, the program code configured to be executed by a processor, the program code comprising:
program code for receiving patient treatment data, the patient treatment data associated with a patient and a treatment test;
program code for, in response to receiving said patient treatment data, storing the patient treatment data at a remote server in real-time; and
program code for generating and displaying a graphical visualization of patient progress based on the patient treatment data.

21. The computer-readable medium of claim 20, further comprising
program code for receiving patient information and generating, by the software application, a patient record based on the patient information, the patient information comprising a medical condition;
program code for providing a plurality of pre-defined treatment tests, at least some of the plurality of pre-defined treatment tests associated with the medical condition;
program code for receiving a selection of at least one of the pre-defined treatment tests; and
program code for associating the selected treatment test with the patient record.

22. The computer-readable medium of claim 21, further comprising:
program code for transmitting the patient record to a remote server;
program code for transmitting the patient treatment data to the remote server, and
wherein the program code for associating the selected treatment test with the patient record comprises program code for transmitting the selected treatment test to the remote server.

23. The computer-readable medium of claim 20, further comprising program code for receiving at least a portion of the patient treatment data from a remote server.

24. The computer-readable medium of claim 20, further comprising program code for receiving a modification of the treatment test, the modification based at least in part on the graphical visualization.

25. The computer-readable medium of claim 24, further comprising program code for transmitting the modification to a remote server.
